(19) United States
(12) Patent Application Publication
(10) Pub. No.: US 2018/0302393 A1
(43) Pub. Date: Oct. 18, 2018

(54) PARAMETERIZED DATA DELIVERY SYSTEM FOR A SPREADSHEET APPLICATION

(71) Applicant: HFA Group, Dallas, TX (US)

(72) Inventor: Leonard MAZUR, Dallas, TX (US)

(21) Appl. No.: 15/490,799

(22) Filed: Apr. 18, 2017

(51) Int. Cl. H04L 29/06; G06F 17/30; G06F 21/62; G06F 17/24

(52) U.S. Cl. CPC H04L 63/083; G06F 17/30554; G06F 3/04847; G06F 17/246; G06F 21/6209

(57) ABSTRACT

A system is provided that includes a client service, a data service, and a report service that interact to extract data from a data source and import the extracted data into a spreadsheet of a spreadsheet application. The client service is an add-in for the spreadsheet application that provides a user interface for selecting reports and inputting values for parameters of the reports, requesting the data service to provide query results of the reports, and importing query results into a spreadsheet. The report service is used to define reports and data source of data for the reports. The data service interacts with the client service, the report service, and the data sources to provide query results to the client service.

### BACKGROUND

A spreadsheet application is a computer program that provides a user interface in which data of a spreadsheet is displayed in rows and columns. Each cell of the spreadsheet (i.e., an intersection of a row and a column) stores data of the spreadsheet that can include numbers, text, formulas, and so on. Spreadsheet applications have been used extensively to organize and analyze data. The sophistication of spreadsheet applications has increased dramatically since VISICALC was introduced in 1979. Currently the most popular and most sophisticated spreadsheet application is MICROSOFT EXCEL (“Excel”). Excel not only provides arithmetic and mathematical functions, but also provides sophisticated statistical and financial functions such as those relating to standard deviations and present values.

Because of the sophisticated functions provided by spreadsheet applications, a user who wants to analyze data will often export data from a software or web application into a spreadsheet compatible format and import the data into a spreadsheet application. Many business applications allow data to be exported into an Excel or comma-separated value (“CSV”) format. Once the data is imported, the user can sort the data, extract relevant portions of the data, perform statistical analyses, and so on. The data can be imported from various data sources, such as SQL Databases or a web API. For example, a structured query language (“SQL”) query can be executed against a database of a SQL server to retrieve rows of data (or records) that match the SQL query. The rows of data can be stored in a file in a CSV format or some other format that the spreadsheet application supports. That file can then be opened by the spreadsheet application to import the data into the spreadsheet application.

Some spreadsheet applications provide tools through which a database can be directly accessed by the spreadsheet application to import data into a spreadsheet. For example, one such tool is an Open Database Connectivity (“ODBC”) interface, which provides an application programming interface (“API”) for accessing database management systems. Such spreadsheet applications provide ODBC drivers that coordinate the submitting of a query to a database and storing the rows of the query results in a spreadsheet that is open by the spreadsheet application. In addition, various organizations provide “add-ins” through which data provided by the organization (e.g., stock quotes) can be imported into a spreadsheet. An “add-in” is a software component (e.g., a dynamic link library (“DLL”)) that can be installed so that the spreadsheet application can invoke the functionality of the add-in.

### BRIEF DESCRIPTION OF THE DRAWINGS

FIG. 1 illustrates a display page of a spreadsheet application with a report selected from a report pane in some embodiments.

FIG. 2 illustrates a display page of a spreadsheet application with the report specified by a formula in some embodiments.

FIG. 3 illustrates a display page of a report service for defining a data source in some embodiments.

FIG. 4 illustrates a display page of a report service for defining a report in some embodiments.

FIG. 5 illustrates a display page of a report service for providing query results of the test of a report in some embodiments.

FIG. 6 is a block diagram that illustrates components of an parameterized spreadsheet data delivery system in some embodiments.

FIG. 7 is a flow diagram that illustrates the processing of an access report component of the client service in some embodiments.

FIG. 8 is a flow diagram that illustrates the processing of a run report component of the client service in some embodiments.

FIG. 9 is a flow diagram that illustrates the processing of an access report component of the data service in some embodiments.

FIG. 10 is a flow diagram that illustrates the processing of a run report component of the data service in some embodiments.

FIG. 11 is a flow diagram that illustrates the processing of an access report component of the report service in some embodiments.

FIG. 12 is a flow diagram that illustrates the processing of a retrieve query component of the report service in some embodiments.

FIG. 13 is a flow diagram that illustrates processing of a define report component of a report service in some embodiments.

### DETAILED DESCRIPTION

A method and system that delivers data to a spreadsheet application is provided. In some embodiments, a parameterized spreadsheet data delivery (“PSSDD”) system provides a client service, a data service, and a report service that support extracting data from various data sources and importing the extracted data into a spreadsheet of a spreadsheet application. The PSSDD system may interface with an authentication service (e.g., Security Token Service of Microsoft Corporation) to authenticate user. The client service may be provided by an add-in that is installed in a spreadsheet application that executes on a client computing device or that executes on a computing device of a cloud data center that receives input from and provides output to a client computing device. The client service receives, from a data service, report information for a report that can be run to extract data from a data source. A report is defined by a report definition that may include an identifier of the data source on which the report is run and a query that specifies the data to be extracted from the data source. The report definition may also identify one or more parameters for the query whose value is to be provided by the spreadsheet application. The report information may include a report name and the identification of the parameter. The client service receives from a user a selection of the report and may also receive from the user an input value for a parameter. For example, the client service may display the report name in a pane adjacent to a pane in which the spreadsheet application displays cells of a spreadsheet. When the user selects the report name, the client service may prompt the user to input a value for the parameter. For example, if the report extracts the total sales over the last few days for a store a company, the parameters may be the identifier of the store and number of days.

The client service then sends to the data service a run request to run the selected report with the input value for the parameter. The data service, which may be hosted by a cloud-based datacenter, submits the query specified by the report definition of the selected report to the data source specified by the report definition to retrieve query results for the report. The query results including records that match the query. Continuing with the total sales example, the query results may include a column for date and a column for total sales and a row for each of the last five business days. The client service then receives from the data service the query results that include the records that match the query. The client service inserts into a spreadsheet of the spreadsheet application the records that match the query. The location in the spreadsheet of the query results may be stored by the add-in. When the user wants to refresh the query results (e.g., by selecting a refresh button), the add-in can overwrite the prior query results. In this way, formulas in cells that access the query results can rely on the updated query results being stored in the same location as the original query results. For example, the client service may insert the name of the columns “Date” and “Total Sales” into cells A1 and B1, respectively, and the dates into cells A2-A6 and the stock prices into cells B2-B6. Although described primarily as implemented as an add-in, the client service may be implemented as an executable that interface with the spreadsheet application using, for example, an API provided by the spreadsheet application.

In some embodiments, the report service, which may be cloud-based, allows reports to be defined so that they can be made available to users of spreadsheet applications. The report service may provide display pages (e.g., web pages) through which a user can define reports. For example, an administrator for a company may use the report service to define reports that may be used by the employees of the company. In addition to defining the reports, the report service may allow the administrator to define permissions indicating which employees or groups of employees (e.g., human resources personnel) are authorized to access each report. The report service allows the data sources for reports to be specified. For example, a data source may be specified by a uniform resource locator (“URL”) (e.g., https://acme.com/source1) along with credentials used to access the data source. A report may be defined by specifying a data source, a query, and a parameter for the query. After the reports are defined, the report service receives from a data service an access report request for accessing report information for reports that a user is authorized to access. In response to receiving the access report request, the report service identifies the reports that the user is authorized to access as specified by the permissions and sends to the data service the report information for those reports. After a user selects to run a report, the report service may receive from the data service a run request for the report. In response to receiving the run request, the report service retrieves the query and associated data source information for the report and sends to the data service the query and the data source information.

In some embodiments, the data service provides, to a client service of a spreadsheet application executing a client computing system, report information for reports that users are authorized to access and query results after running reports. The data service receives from the client service an access report request for report information for a report that a user is authorized to access. The access report request may include credentials (e.g., user name and password) of the user that allow the user access to the data service. The data service may employ an authentication service to authenticate the user based on credentials. If the user is authenticated, then the authentication service may provide a user token to the data service. The data service then retrieves from the report service the report information for the reports that the user is allowed to access. The report information for at least some of the reports may indicate a parameter to be specified by the spreadsheet application (e.g., input by the user). The data service may provide the user token to the report service to identify the user. The data service then sends to the client computing system the report information. After the user selects a report to be run, the data service receives from the client computing system a run report request to run the report. The run report request specifies the report and a value for the parameter of the report. The data service then retrieves from the report service the query along with access information for the data source (e.g., identification and credentials) for that report. The data service sends to the data source the query with the value for the parameter. The data service receives from the data source query results for the query and sends to the client computing system the query results so that the spreadsheet application can add the query results to a spreadsheet.

In some embodiments, the PSSDD system may provide a fully parameterized report for a data source. For example, if the data source is an SQL server, then a report may be defined for a data source that does not specify a query (e.g., no select statement). When a user selects such a fully parameterized report, the client service prompts the user to enter the query. For example, the user may enter the following query

select*from Sales where Date>=01/01/2017.

When the report is ran, the query is sent as a parameter to the data service, which forwards the parameter as the query to the data source. A function for inclusion in a formula of a spreadsheet may also be defined for a fully parameterized query. For example, the fully parameterized function may be entered in a cell as

=DD_FPFunction(“select*from Sales where Date>=01/01/2017”).

Since many users may not be familiar with the SQL language, the PSSDD system may allow a user to enter the content of a query using syntax different from that of an SQL query. For example, a fully parameterized function may be specified as follows:

DD_FPFunction(table [,columns], criteria)

As a user enters the function into a cell, the client service may provide assistance when selecting actual parameters for the formal parameters of the function. The assistance may include providing drop-down lists for the selection of a table of the data source and the columns of the table and providing a parser to ensure that the syntax, which need not be SQL compatible, of the criteria is correct. The report service may provide the schema of a data source to the client service to ensure that the query for a fully parameterized report or function is syntactically correct. An actual parameter may also be indicated by reference to a cell or cells that contain the value(s) of the actual parameter. Some of the formal parameters of such a function or report may have default actual parameters or may have pre-defined values. For example, one function may be pre-defined to specify a date range of the previous year, and another function may be predefined to specify a date range of the current year. In both cases, the function may be defined that does not include an actual parameter for the criteria.

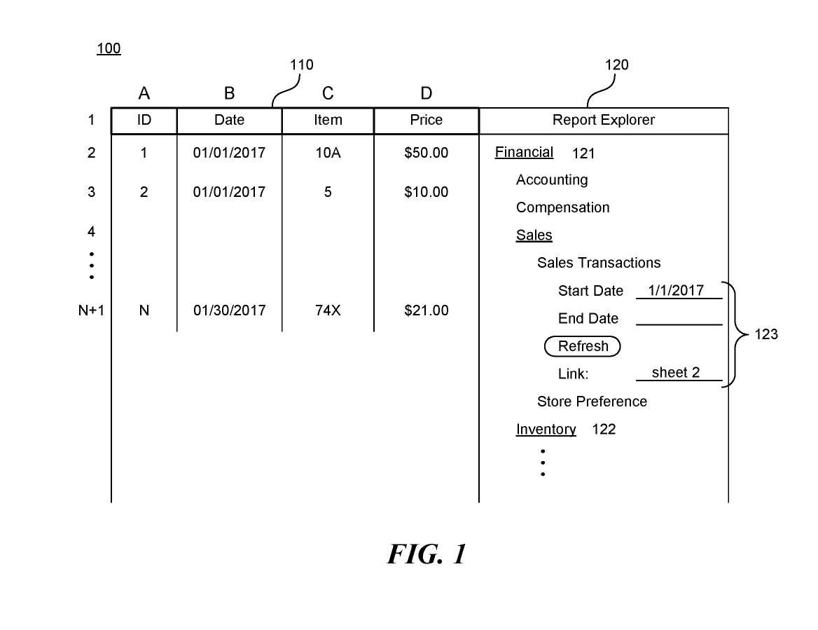

FIG. 1 illustrates a display page of a spreadsheet application with a report selected from a report pane in some embodiments. A display page 100 includes a spreadsheet pane 110 and a report pane 120. The report pane is provided by a client service that may be installed as an add-in to the spreadsheet application. The report pane includes a hierarchical organization of reports such as financial reports 121 and inventory reports 122. The financial reports include an accounting report, a compensation report, and a collection of sales reports that include a sales transactions report and a store performance report. After the user has selected the sales transactions report, the client service displays a user interface 123 for inputting of values for the parameters of the sales transactions report. The parameters include a start date and an end date. The link field is used to specify the sheet of the spreadsheet into which the query results of the sales transactions report are to be imported. After the user has specified the start date and the end date, the user selects the refresh button to run the report and import the query results into the spreadsheet. The spreadsheet pane shows the results of the report. The names of the columns are displayed in the first row of the spreadsheet, and the records of the query results are displayed in the subsequent rows of the spreadsheet. In this example, the client service imports the query results starting at cell A1 by default. The client service may alternatively provide a field in the user interface 123 through which the user can specify a different starting cell for the query results. As another alternative, the client service may use a cell that is currently selected as the starting cell. In some embodiments, the client service may provide global parameters whose value can be set once and subsequently used as values for parameters of different reports. Also, rather than specifying a value for a parameter in user interface 123, the client service may allow the user to specify a cell (e.g., F6) of the spreadsheet from which the value for the parameter is to be retrieved.

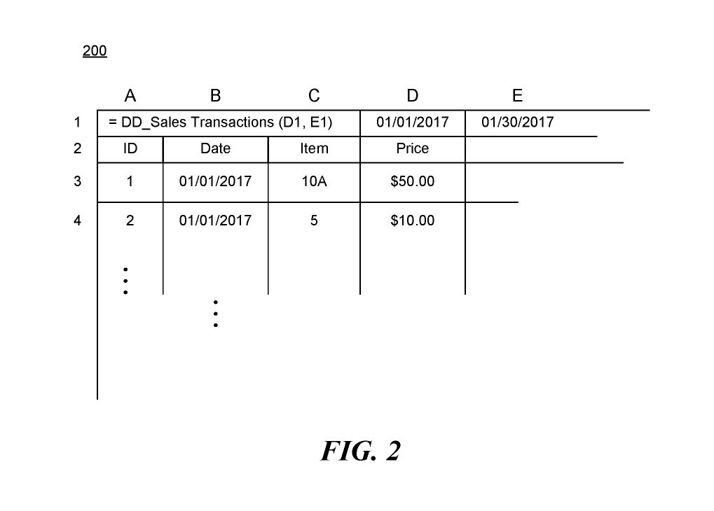

FIG. 2 illustrates a display page of a spreadsheet application with the report specified by a formula in some embodiments. A display page 200 (e.g., web page) illustrates that a formula has been entered into cell A1 for running a report. The client service may register with the spreadsheet application functions that can be used within the formulas. In this example, the client service has registered with the spreadsheet application a function named “DD_SalesTransactions” for running the sales transactions report. In this example, the values for the start date and end date are provided as the parameters of the function, which are specified by cells D1 and E1. After the formula of cell A1 is specified, the spreadsheet application invokes the client service to perform the behavior associated with the registered function. After the client service receives the query results for the sales transactions report, the client service inserts the query results starting at the row following the row in which the sales transaction function was specified in the formula. As the user enters the formula, the client service may display information relating to the parameters. For example, if a parameter is a country, the client service may provide a drop-list of countries to assist in specifying the value for the parameter. The client service may register to receive events (e.g., keystrokes) of the spreadsheet application to support the providing of such assistance. The client service also tracks the range (e.g., A2:D4) of the spreadsheet into which the query results are stored. When the report is refreshed, the client service can then remove the previous query results for that report and import the new query results. The client service may also allow a user to remove query results without importing new query results.

In some embodiments, the PSSDD system may support the display a pop-up window to assist a user when entering a formula such as the formula of cell A1 of display page 200. For example, if a user enters a question mark within the parenthesis of the formula, the PSSDD system may display a pop-up window with information describing the formal parameters of the function and columns returned by the function. The pop-up window may include a tab for displaying the formal parameter information and another tab for displaying the column information. The formal parameter information may include a description of the function and, for each formal parameter, its name, type, and description. The column information may include, for each column, its name, type, cell format, and description. The report service may automatically generate the pop-up window based on information collected when a report was defined. Alternatively, the report service may provide a display page to allow an administrator to define the content of a pop-up window or to modify the content of an automatically generated pop-up window.

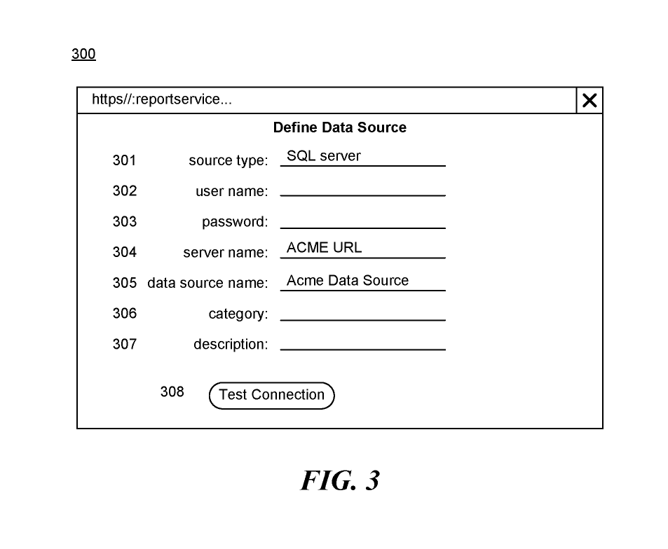

FIG. 3 illustrates a display page of a report service for defining a data source in some embodiments. A display page 300 includes various fields for defining a data source. A source type field 301 allows an administrator to specify the type of the data source such as SQL server via a drop-down list of the types of data sources supported by the PSSDD system. The types may include a SQL server, a representational state transfer (“restful”) API, and so on. A user name field 302 and a password field 303 allow the administrator to specify credentials for the data source. The credentials may be specified based on an Open AuTHentication (“OATH”) token that generates passwords using soft tokens. A server name field 304 allows the administrator to enter a URL for the data source. A data source name field 305 allows the administrator to provide a name used in identifying the data source, for example, when defining a report. A category field 306 allows the administrator to specify different categories for the data sources. For example, a separate category may be specified for each division within a company. A description field 307 allows the administrator to provide a description of the data source. The category and description may be used to help identify a data source when a report is defined. A test connection button 308 allows the administrator to test the connection to the data source. When the test connection button is selected, the report service attempts to login to the data source and retrieves the schema associated with the data source. The report service can use the schema to help the administrator in defining a report.

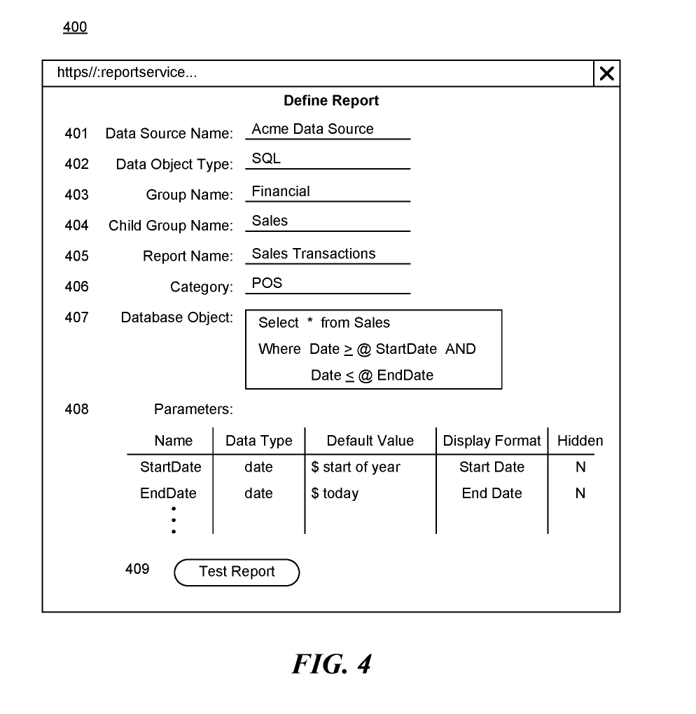

FIG. 4 illustrates a display page of a report service for defining a report in some embodiments. A display page 400 includes various fields for defining a report. A data source name field 401 allows the administrator to specify the data source for the report. The data source name field may provide a drop-down list of data sources that have been defined. A data object type field 402 allows the administrator to specify the type of the data object (i.e., query) for the report. A group name field 403 and a child group name field 404 allows the administrator to specify a hierarchy of reports that are provided in the report pane by the client service. A report name field 404 allows the administrator to provide the name of the report. A category field 406 allows the administrator to categorize the various reports, for example, for later searching on the reports defined for each category. A database object field 407 allows the administrator to define the query, for example, an SQL query. The report service may employ a parser for each type of supported data object type along with the schema for the data source to check the syntax of a query. A parameters area 408 lists the parameters for the query. The hidden column indicates whether a parameter is hidden from the user running the report. If a parameter is not hidden, then the spreadsheet application can provide a value for the parameter. For example, a hidden parameter may specify a fixed time range for a report. A test report button 409 allows the administrator to test the report by submitting the query to the data source.

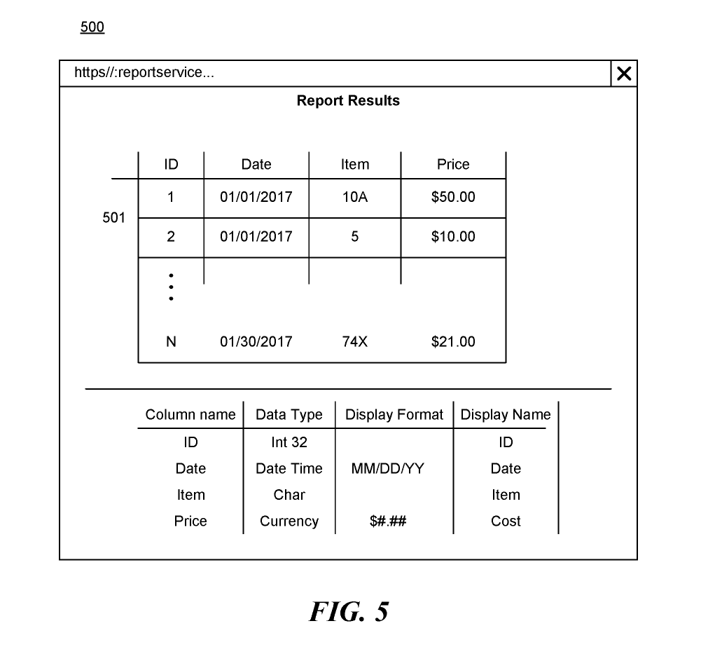

FIG. 5 illustrates a display page of a report service for providing query results of the test of a report in some embodiments. A query results area 501 lists the query results of the test of the report defined in FIG. 4. A schema area 502 provides information relating to the data of the report. Although the data sources and reports are described as being defined primarily by an administrator, the report service may allow any user with sufficient authorization to define data sources and reports. In addition, the client service may provide a user interface through which an administrator can interact with the report service to define data sources and reports.

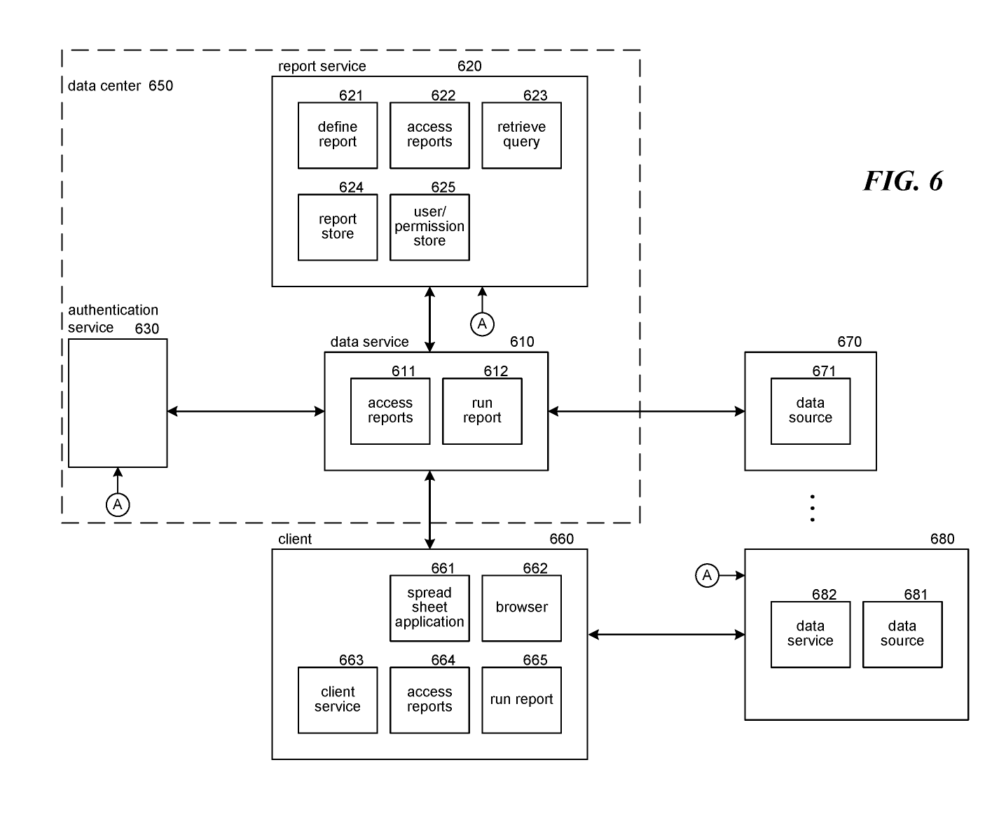

FIG. 6 is a block diagram that illustrates components of an PSSDD system in some embodiments. The PSSDD system includes a data service 610, a report service 620, and an authentication service 630 that executes on servers of a cloud-based datacenter 650. The SSSD system also includes a client service 663 that executes on a client computing device 660. The client computing device includes a spreadsheet application 661, a browser 662, and the client service 663 that includes an access report component 664 and a run report component 665. During execution of the spreadsheet application, when a user wants to use the PSSDD system, the client service invokes the access reports component to receive the credentials of the user for the data service and to coordinate the retrieving of the report information for the reports that the user is authorized access. When a user selects to run a report, the run report component coordinates the running of the report. The browser may be used to interface with the report service to define data sources and reports.

In some embodiments, the add-in run reports asynchronously. For example, many cells of a spreadsheet may specify to run different reports based on a start date stored in a cell. When the start date is changed each of the cells need to be re-calculated by re-running its report. To support the asynchronous running of the reports, the add-in may employ a report queue for the requests to re-run the reports. The add-in may assign a separate thread to control the running of each report. Each thread sends a report request with actual parameters to data service, receives the query results, and inserts the query results into the spreadsheet. In this way, the add-in may have many requests handled simultaneously by a one or more data services.

The data service 610 includes an access report component 611 and a run report component 612. The access report component is invoked to authenticate a user using the authentication service and retrieve from the report service the report information for reports that the user is authorized to access. The run report component is invoked when a user requests to run a report and coordinates the providing of the query results of the report to the client service. The report service 620 includes a define report component 621, an access reports component 622, a retrieve query component 623, a report store 624, and a user/permission store 625. The define report component provides a user interface, for example, via web pages for an administrator to define data sources and reports. The access reports component is invoked to retrieve report information for reports that the user is authorized to access. The retrieve query component is invoked to retrieve the query for a report that is to be run. The report store stores the definitions of the data sources and reports, and the user/permission store stores information indicating which users have access to which data sources and reports.

The PSSDD system is illustrated as supporting data source 671 and data source 681. The data source 671 is a data source that is hosted on a server 670 that data service 610 can access directly. Data source 681, however, is a data source that is hosted on a server 680 that the data source 610 cannot access directly. For example, the data source 681 may be behind a firewall of an organization. To allow access to data sources that cannot be accessed by an external data service, the PSSDD system allows data services, such as data service 682, to be hosted locally with a data source (e.g., on the same server or on a different server). Data source 682 and client 660 may both be hosted behind the firewall of an organization so that client 660 can access reports that use data source 681 using data service 682. Data service 682 interacts directly with the authentication service 630 and the report service 620 in a manner similar to the interactions of the data service 610 with the authentication service 630 and the report service 621. Although the data source is described primarily as being accessed with a SQL query that is sent to a SQL server, a query does not need to be a database query and can be sent to servers other than database servers. For example, a query may be a request for a service of a web service as specified by the Word-Wide Web Consortium, an custom application programming interface (“API”) exposed by a server, and so on.

The computing systems on which the PSSDD system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The computing systems may include servers of a data center, massively parallel systems, smartphone, tablets, laptops, embedded devices, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the PSSDD system. The data transmission media are used for transmitting data via transitory, propagating signals or carrier waves (e.g., electromagnetism) via a wired or wireless connection.

The PSSDD system may be described in the general context of computer-executable instructions, such as program modules and components, executed by one or more computers, processors, or other devices. Generally, program modules or components include routines, programs, objects, data structures, and so on that perform tasks or implement data types. Typically, the functionality of the program modules may be combined or distributed as desired in various embodiments. Aspects of the PSSDD system may be implemented in hardware using, for example, an application-specific integrated circuit (ASIC).

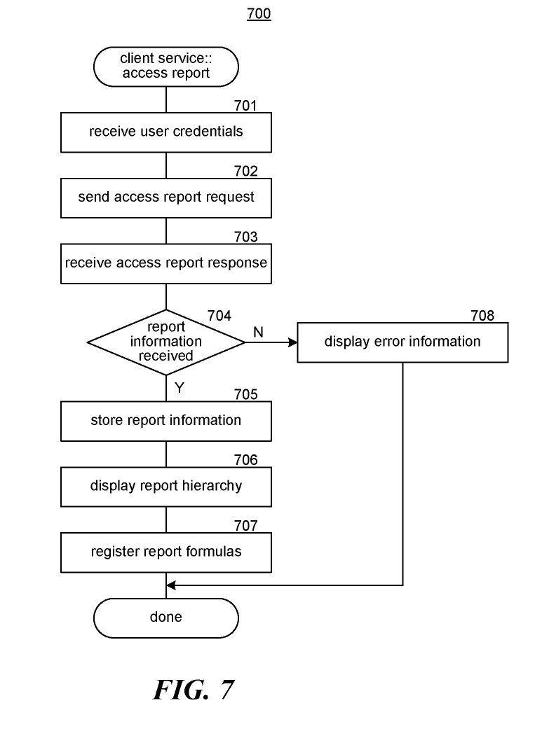

FIG. 7 is a flow diagram that illustrates the processing of an access report component of the client service in some embodiments. An access report component 700 is invoked to authenticate a user and retrieve report information on reports that the user is authorized to access. In block 701, the component receives the user credentials from the user. In block 702, the component sends an access report request to the data service. In block 703, the component receives an access report response. In decision block 704, if report information is received as a result of the user being authorized to access reports, then the component continues at block 705, else the component continues at block 708. In block 705, the component stores the report information. In block 706, the component displays a report hierarchy in the report pane. In block 707, the component registers the reports as functions to be used in formulas of the spreadsheet application and then completes. In block 708, the component displays error information, for example, indicating that the user cannot be authenticated or that the user does not have access to any reports and then completes.

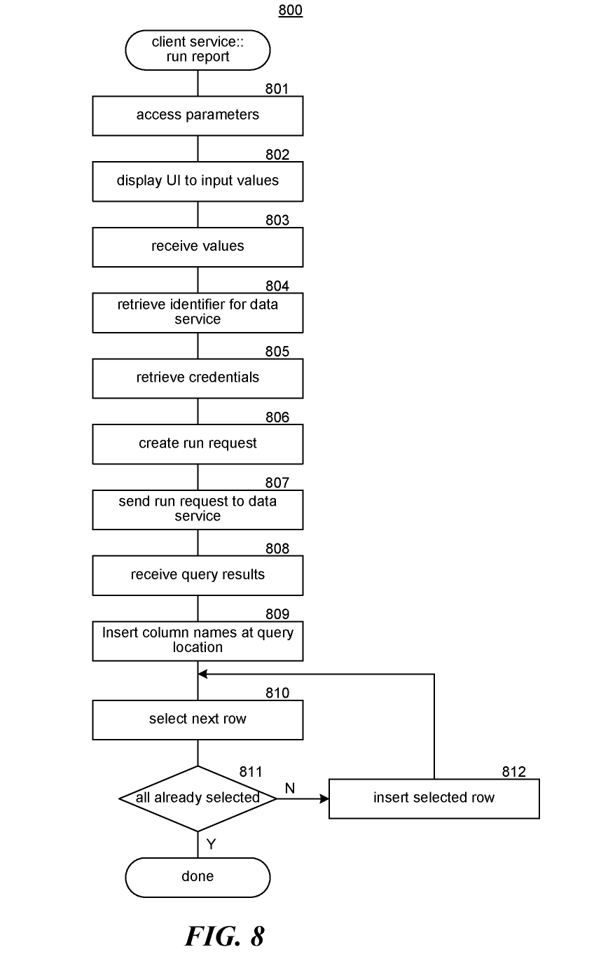

FIG. 8 is a flow diagram that illustrates the processing of a run report component of the client service in some embodiments. A run report component 800 is invoked when a user selects a report that is to be run. In block 801, the component accesses the parameters for the report. In block 802, the component provides a user interface for inputting values for the parameters. In block 803, the component receives the values for the parameters. In block 804, the component retrieves an identifier for the data service that is to provide the report. The client service may be configured to access multiple data services. In such a case, the client service tracks which data services support which reports. In block 805, the component retrieves credentials for the user. In block 806, the component creates a run request that identifies the report, values for the parameters, and credentials of the user. In block 807, the component sends the run request to the data service. In block 808, the component retrieves the query results. In block 809, the component inserts the column names of the query results at a query location such as starting at cell A1. In block 810, the component selects the next row of the query results starting with the first row. In decision block 811, if all the rows have already been selected, then the component completes, else the component continues at block 812. In block 812, the component inserts the selected row at the next row of the spreadsheet and then loops to block 810 to select the next row of the query results. The inserted row may specify a formatting as defined by the report.

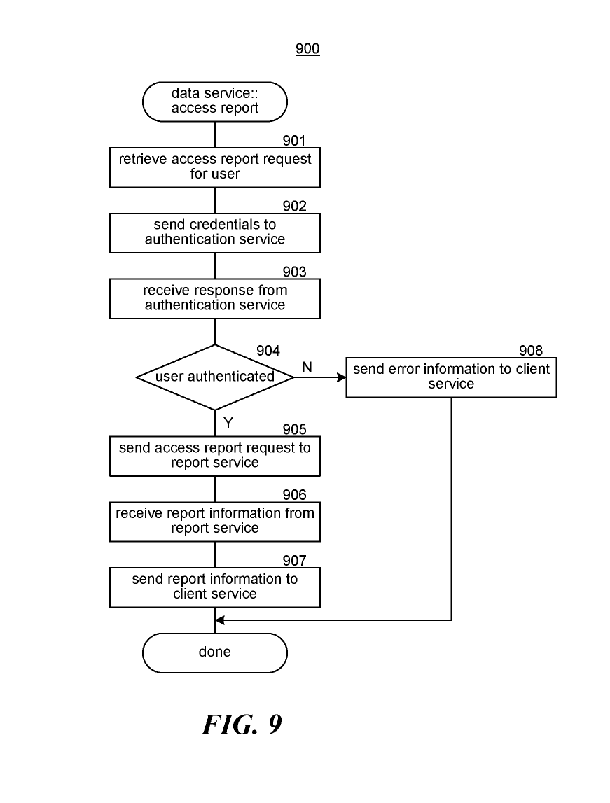

FIG. 9 is a flow diagram that illustrates the processing of an access report component of the data service in some embodiments. An access report component 900 is invoked when a report request is received from a client service and authenticates the user and provides report information to the client service on the reports that the user is authorized access. In block 901, the component retrieves the access report request that has been received from the client service. In block 902, the component sends the credentials of the user to the authentication service. In block 903, the component receives a response from the authentication service. In decision block 904, if the user has been authenticated, then the component continues at block 905, else the component continues at block 908. In block 905, the component sends an access report request to the report service. In block 906, the component receives report information from the report service. In block 907, the component sends the report information to the client service and then completes. In block 908, the component sends error information to the client service indicating that the user has not been authenticated and then completes.

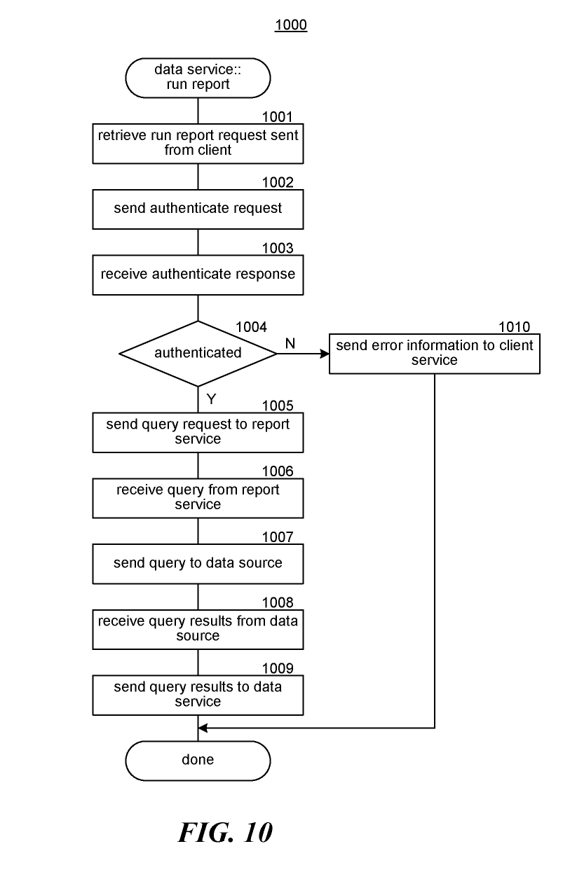

FIG. 10 is a flow diagram that illustrates the processing of a run report component of the data service in some embodiments. A run report component 1000 is invoked when a client service requests to run a report. In block 1001, the component retrieves the run report request that has been received from the client service. In block 1002, the component sends an authenticate request to the authentication service that includes the user credentials. In block 1003, the component receives an authenticate response. In decision block 1004, if the user has been authenticated, then the component continues at block 1005, else the component continues at block 1010. In block 1005, the component sends a query request to the report service that identifies the report. In block 1006, the component receives the query along with an indication of the associated data source from the report service. In block 1007, the component sends the query to the data source. In block 1008, the component receives the query results from the data source. In block 1009, the component sends the query results to the client service and then completes. In block 1010, the component sends an error information to the client service and then completes.

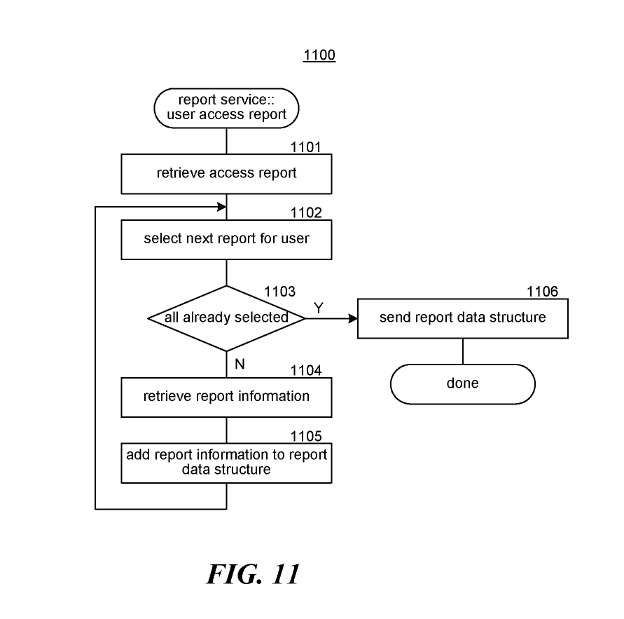

FIG. 11 is a flow diagram that illustrates the processing of an access report component of the report service in some embodiments. An access report component 1100 is invoked when an access report request is received from a data service. In block 1101, the component retrieves the access report. In blocks 1102-1105, the component loops selecting the reports to which the user has access. In block 1102, the component selects the next report that the user has access to. In decision block 1103, if all such reports have already been selected, then the component continues at block 1106, else the component continues at block 1104. In block 1104, the component retrieves the report information for the selected report. In block 1105, the component adds the report information to a report data structure and loops to block 1102 to select the next report. In block 1106, the component sends the report data structure to the data service and then completes.

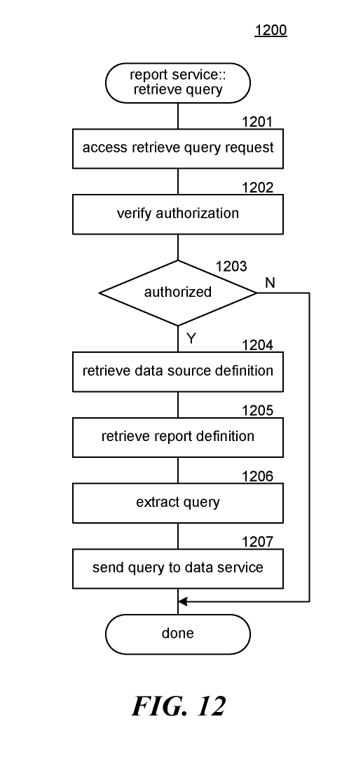

FIG. 12 is a flow diagram that illustrates the processing of a retrieve query component of the report service in some embodiments. A retrieve query component 1200 is invoked to retrieve a query and an identifier of a data source for report. In block 1201, the component accesses the retrieve query request. In block 1202, the component verifies that the user specified in the retrieve query request is authorized to access the report of the retrieve query request. In decision block 1203, if the user is authorized, then the component continues at block 1204, else the component completes. In block 1204, the component retrieves data source definition information for the data source of the query. In block 1204, the component retrieves the report definition for the report. In block 1206, the component extracts the query for the report. In block 1207, the component sends the query along with the data source information to the data service and then completes.

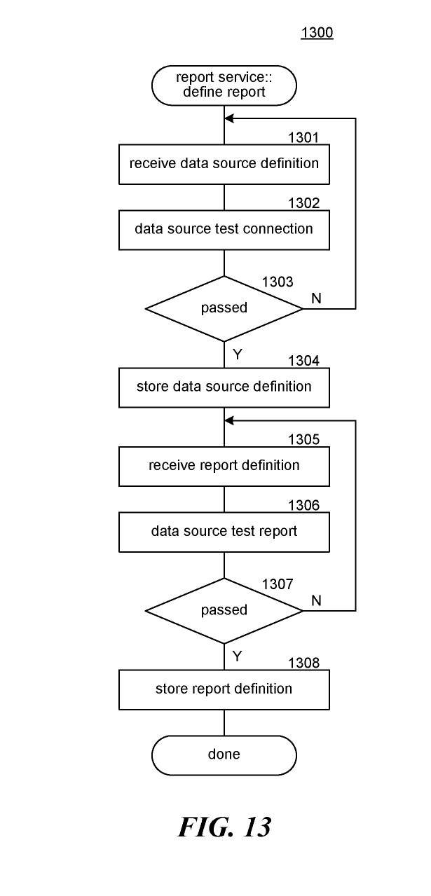

FIG. 13 is a flow diagram that illustrates processing of a define report component of a report service in some embodiments. A defined report component 1300 provides web pages for defining data sources and reports. In blocks 1301-1303, the component provides a web page for defining a data source such as display page 300. In block 1301, the component receives a data source definition. In block 1302, the component tests the connection to the data source. In decision block 1303, if the test passed, then the component continues at block 1304, else the component loops to block 1301 to receive a revised definition. In block 1304, the component stores the data source definition. In blocks 1305-1307, the component provides web pages for inputting a report definition such as display page 400. In block 1305, the component receives the report definition. In block 1306, the report is tested. In decision block 1307, if the test passed, then the component continues at block 1308, else the component loops to block 1305 to retrieve a revised report definition. In block 1308, the component stores the report definition and then completes.

The following paragraphs describe various embodiments of aspects of the PSSDD system. An implementation of the PSSDD system may employ any combination of the embodiments. The processing described below may be performed by a computing device with a processor that executes computer-executable instructions stored on a computer-readable storage medium that implements the PSSDD system.

In some embodiments, a method performed by a computing system for providing parameterized data delivery to a spreadsheet application is provided. The method receives, from a data service, report information for a report. The report information indicates a parameter to be specified by a user. The method receives from the user a selection of the report and an input value for the parameter. The method sends to the data service a request to run the report with the input value. The data service submits a query to a data source to retrieve query results for the report. The query results include records that match the query. The method receives from the data service the query results that include the records that match the query. The method inserts into a spreadsheet of the spreadsheet application the records that match the query. In some embodiments, the data delivery is provided by an add-in to the spreadsheet application. In some embodiments, the data delivery is provided by an application that interfaces with the spreadsheet application. In some embodiments, the method further inserts into the spreadsheet field names of fields of the records. In some embodiments, the method further displays to the user an identification of the report for selection by the user and an indication of the parameter for input of the value by the user. In some embodiments, the identification of the report is displayed in a pane adjacent to a pane that displays the spreadsheet. In some embodiments, the method further registers the report as a function with the spreadsheet application so that the selection of the report and the input value can be received via entry of a formula into a cell of the spreadsheet. In some embodiments, the method further receives credentials from the user and sends the credentials to the data service to ensure that the user is authorized to access the report.

In some embodiments, a method performed by a data service executing on a first computing system for providing query results of a report to a spreadsheet application executing on a second computing system is provided. The method receives from the second computing system an access report request for the report information for the report. The report request originates from the spreadsheet application. The method retrieves from a report service the report information. The report information indicates a parameter to be specified by the spreadsheet application. The method sends to the second computing system the report information. The method receives from the second computing system a run report request to run the report. The run report request specifies a value input by the user for the parameter. The method retrieves from the report service a query for the report along with access information for the data source of the report. The method sends to the data source the query, the query specifying the value. The method receives receiving from the data source query results for the query. The method sends to the second computing system the query results so that the spreadsheet application can import the query results into a spreadsheet. In some embodiments, the access report request includes credentials of the user and the method further sends to an authentication service an authentication request to authenticate the user. The authentication request includes the credentials. The method receives from the authentication service a user token indicating that the user has been authenticated. In some embodiments, the method further sends to the report service the user token wherein the report service determines whether the user is authorized to access the report. In some embodiments, the retrieving of the query includes sending to the report service a query request for the report and receiving from the report service the query. In some embodiments, the query request includes a user token so that the report service can determine that the user is authorized to access the report. In some embodiments, the data service and the report service are provided by a cloud-based datacenter. In some embodiments, the report service is provided by a cloud-based datacenter and the data service is provided a computing system of an organization that provides the data source. In some embodiments, the data service is behind a firewall of the organization.

In some embodiments, a computing system for providing report information for reports for a spreadsheet application is provided. The computing system comprises one or more computer-readable storage media storing computer-executable instructions and one or more processors for executing the computer-executable instructions stored in the one or more computer-readable storage media. The instructions control the computing system to receive report definitions of reports, report definitions including a query and specifying a parameter that the spreadsheet application is to provide. The instructions control the computing system to receive from a data service an access report request for report information for reports that a user is authorized to access. The instructions control the computing system to, in response to receiving the access report request, send to the data service the report information for reports that the user is authorized to access. The instructions control the computing system to receive from the data service a run request for a report. The instructions control the computing system to, in response to receiving the run request, retrieve a query for the report and send to the data service the query for the report.

In some embodiments, a computer-readable storage medium storing an add-in for a spreadsheet application is provided. The add-in provides reports for the spreadsheet application and has instructions. The instructions control the client computing system to retrieve from a data service report information for reports that a user of the spreadsheet application is authorized to use. The report information for a report indicates a parameter to be provided by the spreadsheet application. The instructions control the client computing system to receive from the user a selection of a report. The instructions control the client computing system to send to the data service a request to run the selected report with an input value for the parameter of the selected report. The data service submits a query to a data source to retrieve query results for the selected report. The query results including records that match the query. The instructions control the client computing system to receive from the data service the query results. The instructions control the client computing system to insert into a spreadsheet of the spreadsheet application the records that match the query. In some embodiments, the instructions further control the client computing system to display an indication of the reports that the user of the reports is authorized to access. In some embodiments, the instructions further control the client computing system to retrieve the input value for the parameter of the selected report to be retrieved from a cell of the spreadsheet.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. For example, the PSSDD system may provide an update function in which the client service can automatically check whether an update to the add-in is available and provide the user with an option of retrieving the updated add-in. Accordingly, the invention is not limited except as by the appended claims.

I/We claim:

1. A method performed by a computing system for providing parameterized data delivery to a spreadsheet application, the method comprising:
receiving, from a data service, report information for a report, the report information indicating a parameter to be specified by a user;
receiving from the user a selection of the report and an input value for the parameter;
sending to the data service a request to run the report with the input value, wherein the data service submits a query to a data source to retrieve query results for the report, the query results including records that match the query;
receiving from the data service the query results that include the records that match the query; and
inserting into a spreadsheet of the spreadsheet application the records that match the query.

2. The method of claim 1 wherein the data delivery is provided by an add-in to the spreadsheet application.

3. The method of claim 1 wherein the data delivery is provided by an application that interfaces with the spreadsheet application.

4. The method of claim 1 further comprising after receiving the query results, inserting into the spreadsheet field names of fields of the records.

5. The method of claim 1 further comprising displaying to the user an identification of the report for selection by the user and an indication of the parameter for input of the value by the user.

6. The method of claim 5 wherein the identification of the report is displayed in a pane adjacent to a pane that displays the spreadsheet.

7. The method of claim 1 further comprising registering the report as a function with the spreadsheet application so that the selection of the report and the input value can be received via entry of a formula into a cell of the spreadsheet.

8. The method of claim 1 further comprising:
receiving credentials from the user; and
sending the credentials to the data service to ensure that the user is authorized to access the report.

9. A method performed by a data service executing on a first computing system for providing query results of a report to a spreadsheet application executing on a second computing system, the method comprising:
receiving from the second computing system an access report request for the report information for the report, the report request originating from the spreadsheet application;
retrieving from a report service the report information, the report information indicating a parameter to be specified by the spreadsheet application;
sending to the second computing system the report information;
receiving from the second computing system a run report request to run the report, the run report request specifying a value input by the user for the parameter;
retrieving from the report service a query for the report along with access information for the data source of the report;
sending to the data source the query, the query specifying the value;
receiving from the data source query results for the query; and
sending to the second computing system the query results so that the spreadsheet application can import the query results into a spreadsheet.

10. The method of claim 9 wherein the access report request includes credentials of the user and further comprising:
sending to an authentication service an authentication request to authenticate the user, the authentication request including the credentials; and
receiving from the authentication service a user token indicating that the user has been authenticated.

11. The method of claim 10 further comprising sending to the report service the user token wherein the report service determines whether the user is authorized to access the report.

12. The method of claim 9 wherein the retrieving of the query includes sending to the report service a query request for the report and receiving from the report service the query.

13. The method of claim 12 wherein the query request includes a user token so that the report service can determine that the user is authorized to access the report.

14. The method of claim 9 wherein the data service and the report service are provided by a cloud-based datacenter.

15. The method of claim 9 wherein the report service is provided by a cloud-based datacenter and the data service is provided a computing system of an organization that provides the data source.

16. The method of claim 15 wherein the data service is behind a firewall of the organization.

17. A computing system for providing report information for reports for a spreadsheet application, the computing system comprising:
one or more computer-readable storage media storing computer-executable instructions for controlling the computing system to:
receive report definitions of reports, report definitions including a query and specifying a parameter that the spreadsheet application is to provide;
receive from a data service an access report request for report information for reports that a user is authorized to access;
in response to receiving the access report request, send to the data service the report information for reports that the user is authorized to access;
receive from the data service a run request for a report; and
in response to receiving the run request,
retrieve a query for the report; and
send to the data service the query for the report; and
one or more processors for executing the computer-executable instructions stored in the one or more computer-readable storage media.

18. A computer-readable storage medium storing an add-in for a spreadsheet application, the add-in for providing reports for the spreadsheet application, the add-in having instructions comprising instructions that control a client computing system to:
retrieve from a data service report information for reports that a user of the spreadsheet application is authorized to use, the report information for a report indicating a parameter to be provided by the spreadsheet application;
receive from the user a selection of a report;
send to the data service a request to run the selected report with an input value for the parameter of the selected report, wherein the data service submits a query to a data source to retrieve query results for the selected report, the query results including records that match the query;
receive from the data service the query results; and
insert into a spreadsheet of the spreadsheet application the records that match the query.

19. The computer-readable storage medium of claim 18 wherein the instructions further control the client computing system to display an indication of the reports that the user of the reports is authorized to access.

20. The computer-readable storage medium of claim 18 wherein the instructions further control the client computing system to retrieve the input value for the parameter of the selected report to be retrieved from a cell of the spreadsheet.
